(19) United States
(12) Patent Application Publication
(10) Pub. No.: US 2023/0035373 A1
(43) Pub. Date: Feb. 2, 2023

(54) Brake Dust Particle Filter with a Filter Insert

(71) Applicant: MANN+HUMMEL GmbH, Ludwigsburg (DE)

(72) Inventors: Tobias Woerz, Leutenbach (DE); Benedikt Weller, Steinheim (DE); Lukas Bock, Bietigheim-Bissingen (DE); Franc Pricken, Lauffen (DE); Steffen Pfannkuch, Ludwigsburg (DE); Theodor Rockinger, Marklkofen (DE); Andreas Aigner, Pilsting (DE); Ludwig Bammersperger, Reisbach (DE); Philipp Plenk, Landau/Isar (DE); Klaus Gehwolf, Mamming (DE); Oliver Reiners, Weyhe (DE); Klaus Mack, Hardthausen (DE)

(21) Appl. No.: 17/831,707

(22) Filed: Jun. 3, 2022

(30) Foreign Application Priority Data
Jun. 9, 2021 (DE) 1020201114797.2

(51) Int. Cl. F16D 65/00; B01D 46/00; B01D 46/52

(52) U.S. Cl. CPC F16D 65/0031; B01D 46/0005; B01D 46/521; B01D 2271/02; B01D 2265/06; B01D 2265/04; B01D 2275/206

(57) ABSTRACT

A brake dust particle filter for a disc brake assembly is provided with a housing that has a first housing side wall, a second housing side wall, and a housing circumferential wall, wherein the housing circumferential wall extends between the first housing side wall and the second housing side wall. A filter insert with a filter medium is arranged in the housing and extends along one of the first and second housing side walls and along the housing circumferential wall. The filter insert has a curved circumferential edge. The housing has a curved receiving groove. The curved circumferential edge engages the curved receiving groove. The filter insert is L-shaped and is configured to at least partially cover a friction surface and a circumferential surface of a brake disc of the disc brake assembly. The curved circumferential edge of the filter insert projects past the filter medium.

### CROSS REFERENCE TO RELATED PATENT APPLICATIONS

This application is a continuation of, expressly incorporates by reference, and claims the benefit of and priority to co-pending German Patent Application No. DE 102021114797.2 filed on Jun. 9, 2021. The contents of the application are herein expressly incorporated by reference in its entirety.

### BACKGROUND OF THE INVENTION

The invention concerns a brake dust particle filter for a disc brake assembly, wherein the brake dust particle filter comprises a housing and a filter insert; a disc brake assembly with a brake dust particle filter; a filter insert for a brake dust particle filter; as well as a use of the filter insert in a brake dust particle filter.

Abraded particles of brakes, so-called brake dust, contributes to input of particulate matter into the environment by motor vehicles. The abraded particles are comprised in this context in particular of particles that have been abraded from a brake disc and brake pads. In addition to the environmental load, brake dust leads to persistent soiling which may impair the function of the brake and of components adjoining the brake. In particular on aluminum rims, deposits of brake dust are also considered esthetically unpleasing.

US 2018/0031059 A1 discloses a brake dust particle filter in which ring sectors form a housing for a filter. The filter is comprised of an axially inner filter in an inner ring sector and an axially outer filter in an outer ring sector.

Since the filter elements of brake dust particle filters become clogged over time, they must be exchanged occasionally. An old filter element must be removed for this purpose and a new filter element inserted. For the effectiveness of the brake dust particle filter, it is important that a portion as large as possible of an air flow laden with brake dust particles is guided through the filter element.

It is an object of the invention to improve the effectiveness of a brake dust particle filter with a filter insert that is easy to exchange.

### SUMMARY OF THE INVENTION

This object is solved by a brake dust particle filter fora disc brake assembly with a brake disc and a brake caliper, wherein the brake dust particle filter comprises a housing with two housing side walls and with a housing circumferential wall extending between the housing side walls, wherein in the housing a filter insert, in particular L-shaped in cross section, with a filter medium is received that extends along one of the housing side walls and along the housing circumferential wall, wherein the filter insert comprises a curved circumferential edge that engages a curved receiving groove of the housing.

This object is solved by a disc brake assembly comprising a brake disc, a brake caliper, and a brake dust particle filter according to the invention.

This object is solved by a filter insert for a brake dust particle filter, in particular brake dust particle filter according to the invention, wherein the filter insert is L-shaped, in particular L-shaped in cross section, and comprises a filter medium, and wherein the filter insert is configured for at least partial coverage of a friction surface and of a circumferential surface of a brake disc, and wherein the filter insert comprises a curved circumferential edge, which, preferably in axial direction, projects past the filter medium.

This object is solved by a use of a filter insert according to the invention in a brake dust particle filter, preferably a brake dust particle filter according to the invention.

### Brake Dust Particle Filter According to the Invention

A brake dust particle filter is provided according to the invention for a disc brake assembly with a brake disc and a brake caliper. The brake dust particle filter comprises a housing with two housing side walls and with a housing circumferential wall extending between the housing side walls. The housing serves for at least partially covering the brake disc. The housing forms in other words a housing interior for at least partially receiving the brake disc. The housing side walls are spaced apart from each other in axial direction. The brake disc can be arranged between the housing side walls. The housing circumferential wall is located radially outwardly. The housing circumferential wall serves for at least partial coverage of a circumferential surface of the brake disc.

Directional information, for example, axial or radial, relate to an axis of rotation of the brake disc for the illustration of the present invention. For the description of the brake dust particle filter and of the filter insert, reference is being had thus to the state mounted at the disc brake assembly.

The brake dust particle filter comprises an L-shaped filter insert with a filter medium. The L-shape of the filter insert can be seen in particular in a cross section whose section plane contains the axis of rotation of the brake disc or extends parallel thereto. The filter insert is received in the housing. The filter insert extends (with one of the legs of the L) along one of the housing side walls. Furthermore, the filter insert (with the other leg of the L) extends along the housing circumferential wall. The filter insert can be a filter insert according to the invention described below. Further features of the filter insert according to the invention can be provided for the filter insert of the brake dust particle filter according to the invention.

The filter insert comprises a curved circumferential edge. The curved circumferential edge extends preferably along the free end of the leg of the filter insert which is arranged at the housing circumferential wall. The housing comprises a curved receiving groove. The receiving groove extends preferably along one of the housing side walls. The curved circumferential edge engages the curved receiving groove. The circumferential edge and the receiving groove (in the mounted state) can extend at least in sections concentrically to the axis of rotation of the brake disc. Due to the circumferential edge engaging the receiving groove, on the one hand, the filter insert is sealed relative to the housing. An escape of unfiltered air from the brake dust particle filter is thereby prevented. On the other hand, the filter insert is fixed in the housing due to the circumferential edge engaging the receiving groove. This simplifies mounting and fastening of the filter insert in the housing.

The filter insert is in principle formed by a structural unit that can be handled jointly.

The components of the filter insert are preferably connected non-detachably to each other.

In a preferred embodiment, a rope seal is arranged in the receiving groove. The sealing action of the filter insert relative to the housing can be further improved in this way. Typically, the rope seal contains ceramic fibers and/or glass fibers, but thermally resistant fibers are conceivable. In particular, the rope seal can be comprised of ceramic fibers or glass fibers. Such a rope seal withstands temperatures of up to 700° C. occurring in a brake device. The rope seal can contain the fibers in the form of a fabric. In the mounted state, the rope seal is positioned so as to contact the circumferential edge and the receiving groove. The rope seal can be a solid rope or a hollow cord. Preferably, the circumferential edge presses centrally on the rope seal.

In an alternative embodiment, the receiving groove and the circumferential edge engaging the receiving groove form a labyrinth seal. This can simplify mounting of the filter insert while still providing a good sealing action.

Advantageously, the housing is of a two-part configuration. A first one of the housing side walls can be formed at a first housing part. The second one of the housing side walls can be formed at a second housing part. Preferably, the housing circumferential wall is formed at the second housing part. The first housing part is typically arranged axially inwardly (i.e., facing a central plane of a vehicle with the brake dust particle filter or axially inside of the brake disc at the vehicle), the second housing part can be correspondingly arranged axially outwardly (i.e., facing outwardly or axially outside of the brake disc at the vehicle).

The first housing part can comprise a fastening device for fastening the brake dust particle filter at a vehicle structure, for example, a wheel carrier. The fastening device can comprise one or a plurality of cutouts for passing through fastening means, for example, screws. Moreover, the first housing part can form at least partially a splash guard of the disc brake assembly.

Particularly preferred, the two housing parts are detachably connected at each other. For exchange of the filter insert, the housing can therefore be opened and closed in a simple manner.

Advantageously, the receiving groove is formed in the first housing part. When opening the housing, the first housing part typically remains at the vehicle. This simplifies the exchange of the filter insert. The filter insert can be pre-mounted at the second housing part and can then be attached with the second housing part at the first housing part. Alternatively, the filter insert by itself can be inserted into the circumferential groove of the first housing part and then covered by the second housing part.

The first housing part can comprise axial fastening projections at which the filter insert and the second housing part can be attached. In other words, the fastening projections extend in axial direction. The fastening projections can extend from the first side wall to the second side wall. Preferably, the filter insert can be pushed in axial direction onto the fastening projections. The filter insert can comprise cutouts for engaging the fastening projections.

The fastening projections can be formed as one piece together with the first housing part. This simplifies the initial mounting of the brake dust particle filter.

Alternatively, the fastening projections can be screwed onto the first housing part. This can simplify the manufacture of the first housing part. The fastening projections can be stud bolts. The fastening projections can comprise an outer thread section for engaging an inner thread section of the first housing part.

The filter insert and the second housing part can be clamped in axial direction against the first housing part. This enables mounting from the exterior in axial direction. In radial direction, installation space can be saved in this way. Screws can pass in axial direction through the first housing part and the filter insert and engage the fastening projections.

The filter insert and the second housing part can be clamped in radial direction against the first housing part. This enables mounting at least partially in radial direction. In axial direction, installation space can be saved in this way. Preferably, the filter insert and the second housing part can be clamped against the fastening projections. Screws can pass in radial direction through the first housing part and the filter insert and engage the fastening projections.

The filter insert and the housing, in particular the second housing part, can be fastened at each other from the exterior in radial and/or axial direction, in particular can be screwed to each other. This enables pre-mounting of the filter insert at the second housing part. In addition, the filter element is fixed additionally at the housing. Screws can pass through the housing, in particular the second housing part, as well as the filter insert and can engage corresponding counter threads of the fastening projections.

In a preferred further embodiment, the filter insert comprises at a circumferential wall and/or side wall at least one bore that is present so as to correspond with the positioning of the counter threads of the fastening projections. The screws used for the connection can thus be passed through the filter insert and secure the filter insert indirectly at the first housing part, i.e., by a screw connection of the second housing part at the first housing part.

The circumferential edge of the filter insert can dip in axial direction into the receiving groove of the housing. This can improve the sealing effect in radial direction which is advantageous in particular in internally ventilated brake discs. In addition, this can simplify mounting of the filter insert.

The filter insert can comprise an insert part with a side wall and a circumferential wall. The insert part, in particular viewed in cross section, is L-shaped and provides a support structure for receiving the filter medium as well as for connection to the housing. The side wall of the filter insert can be arranged at, or oppositely positioned to, one of the housing side walls, preferably at the second housing side wall; the circumferential wall of the filter insert can be arranged at, or oppositely positioned to, the housing circumferential wall. In the side wall and/or the circumferential wall of the insert part, advantageously at least one opening is formed which is covered by the filter medium. The opening enables a passage of air through the filter insert, wherein brake dust particles are retained in the filter medium. Preferably, there are openings at the side wall as well as at the circumferential wall.

The filter medium can be held non-detachably at the insert part. The filter medium is preferably welded to the insert part. When the insert part comprises an opening, the filter medium can be welded to a rim of the opening, preferably continuously circumferentially about the opening. An escape of brake dust between the filter medium and the insertion part can be avoided reliably in this way.

Preferably, the filter medium is formed by a pleated bellows. This enlarges the effective filter surface area.

In embodiments in which the insert part has an opening in the side wall as well as in the circumferential wall, the filter medium can be present in two separate filter medium sections that are each connected to a rim of the respective opening.

However, the filter medium can also be of a one-piece configuration. In other words, both legs of an L-shaped filter medium can be obtained by appropriate angular positioning of the one-piece filter medium. Alternatively, the filter medium can be of a multi-part configuration, in particular of a two-part configuration. The two legs of the L-shaped filter medium can be formed correspondingly by a separate filter part, respectively.

The housing circumferential wall can comprise at least one flow opening, preferably a plurality of flow openings which are spaced apart from each other in circumferential direction. The at least one flow opening is in principle arranged such that it is separated by the filter insert from the brake disc and the brake caliper in the mounted state. The at least one flow opening enables an escape of filtered air out of the housing.

### Disc Brake Assembly According to the Invention

The present invention also encompasses a disc brake assembly comprising a brake disc, a brake caliper, and a brake dust particle filter in accordance with the invention described above. In rotational direction of the brake disc upon forward travel of a vehicle with the disc brake assembly, the brake dust particle filter is arranged in principle downstream of the brake caliper. Typically, the brake dust particle filter adjoins immediately the brake caliper. The brake caliper can comprise a brake caliper holder. In the mounted state, the brake disc engages between the housing side walls of the brake dust particle filter. The housing circumferential wall of the brake dust particle filter covers a circumferential surface of the brake disc at least partially. The brake disc can be an internally ventilated brake disc. The brake dust particle filter of the disc brake assembly according to the invention can comprise further features of the brake dust particle filter according to the invention.

### Filter Insert According to the Invention

The present invention also encompasses a filter insert for a brake dust particle filter, in particular for a brake dust particle filter according to the invention described above. The filter insert is embodied L-shaped. The filter insert comprises a filter medium for covering sections of a friction surface and of a circumferential surface of a brake disc. Further in accordance with the invention, the filter insert comprises a curved circumferential edge. The circumferential edge projects, preferably in axial direction, past the filter medium. The circumferential edge serves for engaging a curved receiving groove of a housing. The circumferential edge can extend along the leg, preferably at its free end, of the filter insert correlated with the circumferential surface of the brake disc. The filter medium can be of a one-part or a multi-part configuration.

The filter medium can be non-detachably held at an insert part of the filter insert, In particular can be welded to the insert part. The insert part can comprise at least one opening which is covered by the filter medium. Preferably, the circumferential edge is formed at the insert part.

The filter insert according to the invention can comprise further features of the filter insert of the above-described brake dust particle filter according to the invention.

### Use According to the Invention

Furthermore, the present invention encompasses a use of a filter insert according to the invention described above in a brake dust particle filter, preferably an above described brake dust particle filter according to the invention.

### BRIEF DESCRIPTION OF THE DRAWINGS

Further features and advantages of the invention result from the following detailed description of embodiments of the invention, from the claims as well as with the aid of the Figures of the drawing showing details according to the invention. The afore mentioned and still further explained features can be realized each individually by themselves or several combined in any expedient combinations realized in variants of the invention. The features disclosed in the drawing are illustrated such that the particularities according to the invention can be made clearly visible.

FIG. 1 shows a disc brake assembly according to the invention with a brake disc, a brake caliper, and a brake dust particle filter according to the invention in a schematic perspective view.

FIG. 2 shows the brake dust particle filter of the disc brake assembly of FIG. 1 comprising two housing parts and a filter insert according to the invention in a schematic exploded illustration.

FIG. 3 shows the brake dust particle filter of FIG. 2 in a schematic view with a view radial in relation to an axis of rotation of the brake disc.

FIG. 4 shows the brake dust particle filter of FIG. 2 in a schematic section view with section direction perpendicular to the axis of rotation of the brake disc.

FIG. 5 shows the brake dust particle filter of FIG. 2 in a schematic section view, with section direction parallel to the axis of rotation of the brake disc.

FIG. 6 shows an enlarged schematic illustration of the engagement of a circumferential edge of the filter insert of the brake dust particle filter of FIG. 2 in a circumferential groove of the housing, wherein a ceramic rope seal is arranged in the circumferential groove.

FIG. 7 shows a schematic exploded illustration of a further embodiment of a brake dust particle filter according to the invention with a multi-part housing and a filter insert according to the invention.

FIG. 8 shows the brake dust particle filter of FIG. 7 in a schematic section view with section direction parallel to the axis of rotation of a brake disc.

FIG. 9 shows an enlarged schematic illustration of detail Y of FIG. 8, wherein a circumferential groove of the housing and a projecting circumferential edge of the filter insert form a labyrinth seal.

### DESCRIPTION OF PREFERRED EMBODIMENTS

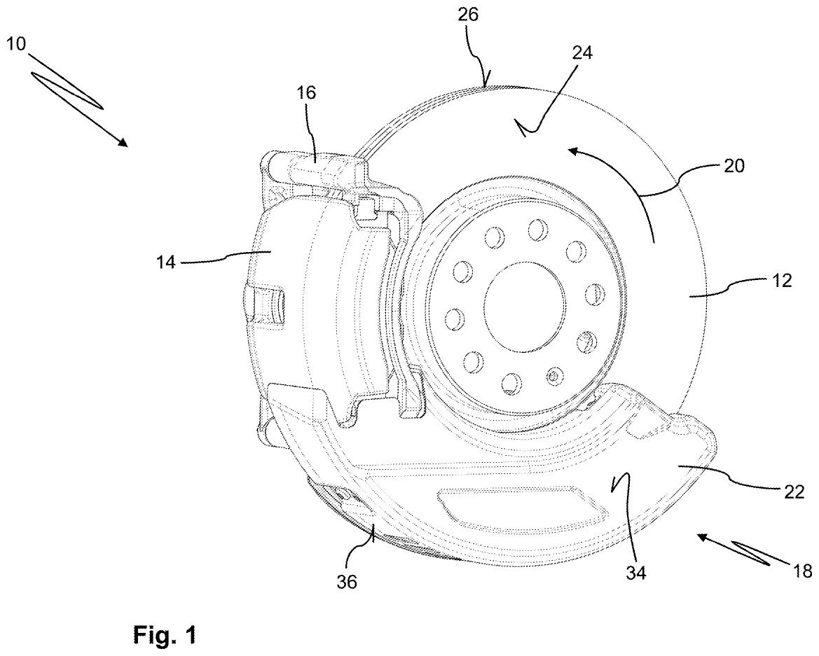

FIG. 1 shows a disc brake assembly 10. The disc brake assembly 10 comprises a brake disc 12 and a brake caliper 14. Here, the brake disc 12 is an internally ventilated brake disc. The brake caliper 14 can be held at a brake caliper holder 16. The disc brake assembly 10 comprises moreover a brake dust particle filter 18. The brake dust particle filter 18 is arranged downstream of the brake caliper 16 in rotational direction 20 of the brake disc 12 (for forward travel of a vehicle with the disc brake assembly 10). A housing 22 of the brake dust particle filter 18 covers partially the two friction surfaces 24 as well as a circumferential surface 26 of the brake disc 12. The housing 22 is arranged immediately adjoining the brake caliper 14.

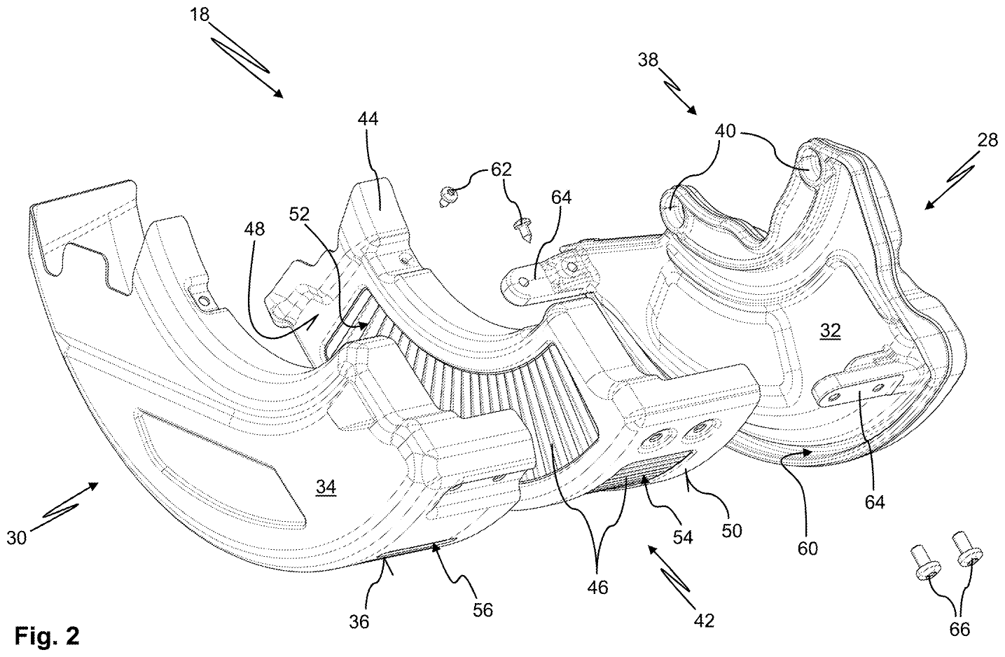

FIG. 2 shows the brake dust particle filter 18 in an exploded illustration. The housing 22 comprises a first housing part 28 and a second housing part 30. At the first housing part 28, a first housing side wall 32 is formed. At the second housing part 30, a second housing side wall 34 is formed. A housing circumferential wall 36 extends in the mounted state from the first housing side wall 32 to the second housing side wall 34. Here, the housing circumferential wall 36 is formed at the second housing part 30 as one piece together with the second housing side wall 34. The housing side walls 32, 34 and the housing circumferential wall 36 define an interior for partially receiving the brake disc 12.

For fastening the brake dust particle filter 18 at a vehicle, a fastening device 38 is provided. Here, the fastening device 38 comprises two cutouts 40 for screwing the brake dust particle filter 18 to the vehicle. The fastening device 38 is presently embodied at the first housing part 28. In the mounted state, the first housing part 28 with the first housing side wall 32 is located at the side of the brake disc 12 which is facing the vehicle; the second housing part 30 with the second housing side wall 34 is located correspondingly at the side of the brake disc 12 which is facing away from the vehicle.

The brake dust particle filter 18 comprises a filter insert 42. In the mounted state, the filter insert 42 is arranged in the housing 22. The filter insert 42 comprises an insert part 44 and a filter medium 46. The filter insert 42 is L-shaped. The insert part 44 comprises a side wall 48 and a circumferential wall 50. The side wall 48 and the circumferential wall 50 extend substantially perpendicularly to each other. In the mounted state, the side wall 48 is arranged at one of the friction surfaces 24 of the brake disc 12; the circumferential wall 50 adjoins the circumferential surface 26 of the brake disc 12. In the mounted state, the filter insert 42 or its side wall 48 and the circumferential wall 50 are arranged between the brake disc 12 and the housing 22, here the second housing part 30, concretely the second housing side wall 34 and the housing circumferential wall 36.

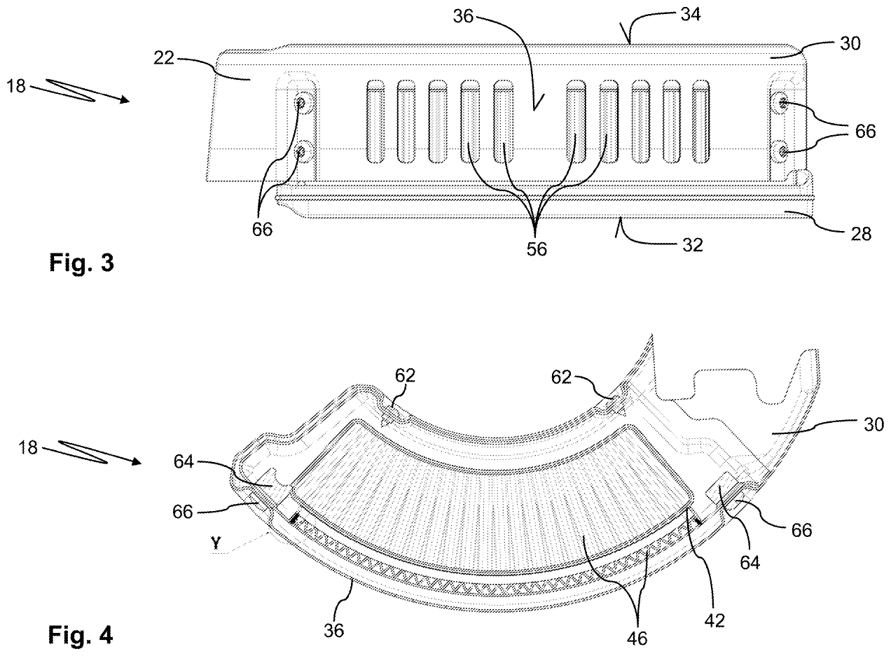

Here, the side wall 48 and the circumferential wall 50 of the insert part 44 each comprise an opening 52, 54. The openings 52, 54 are covered by the filter medium 46. In operation of the brake dust particle filter 18, air flows, coming from the brake disc 12, through the openings 52, 54, wherein entrained brake dust particles are retained in the filter medium 46. The filtered air can exit through a plurality of flow openings 56 from the housing 22, compare FIG. 3. The flow openings 56 are spaced apart form each other here in circumferential direction. The flow openings 56 can be embodied in the housing circumferential wall 36.

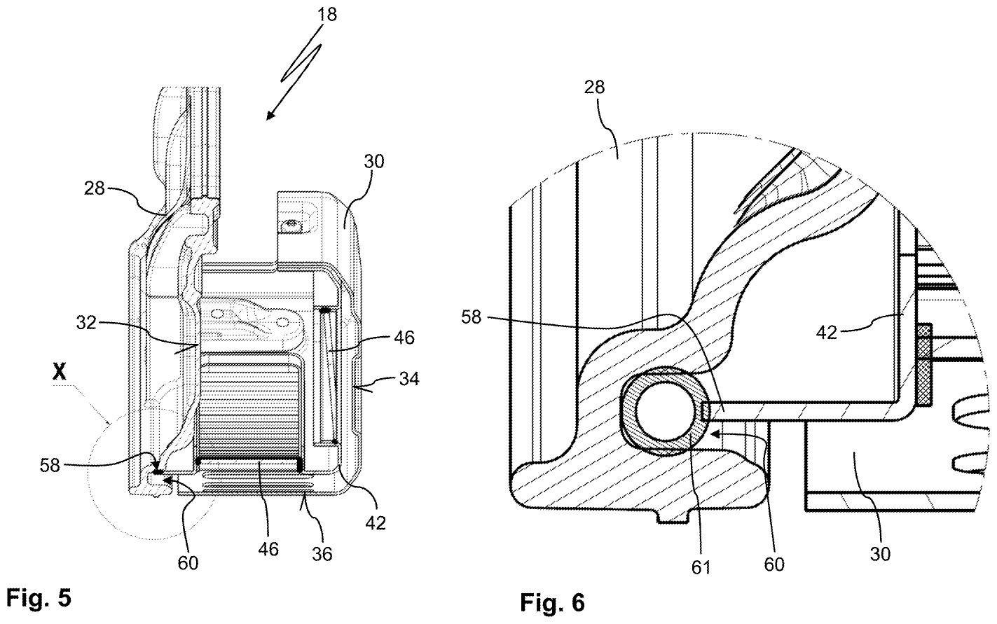

The filter medium 46 comprises here two spaced apart filter parts, compare FIGS. 4 and 5. The two filter parts each are embodied as a pleated (multi-folded) bellows. The filter medium 46 is non-detachably fastened to the insert part 44. The filter medium 46 or the two filter parts can be welded to the insert part 44, in particular circumferentially about the openings 52, 54.

FIG. 5 shows that a curved circumferential edge 58 of the filter insert 42 engages a curved receiving groove 60 of the housing 22. The receiving groove 60 and its curved course can be seen also in FIG. 2. The circumferential edge 58 and the receiving groove 60 can extend at least in sections concentrically to an axis of rotation of the brake disc 12.

The curved circumferential edge 58 is formed at the free end of the circumferential wall 50 of the filter insert 42. Presently, an axial end section of the insert part 44 forms the circumferential edge 58. The circumferential edge 58 projects past the filter medium 46. The circumferential edge 58 projects here in axial direction past the filter medium 46.

The receiving groove 60 is presently embodied at the first housing part 28. Here, the receiving groove 60 is located at the radial outer end of the first housing side wall 32. The receiving groove 60 is open toward the second housing side wall 34. The circumferential edge 58 projects in axial direction into the receiving groove 60.

A rope seal 61 can be compressed in the receiving groove 60 between the circumferential edge 58 of the filter insert 42 and the housing 22, see FIG. 6. The rope seal 61 can comprise ceramic fibers, in particular be comprised of ceramic fibers. Alternatively, the rope seal can comprise glass fibers, in particular be comprised of glass fibers. Presently, the rope seal 61 is embodied as a hollow cord with a central cutout. Alternatively, the rope seal can be a solid rope with massive cross section (not illustrated in detail). In relation to the cross section of the rope seal 61, the circumferential edge 58 can press centrally onto the rope seal 61. The circumferential edge 58 dips correspondingly centrally into the receiving groove 60.

The two housing parts 28, 30 and the filter insert 42 are detachably fastened at each other, compare in particular FIG. 2. The filter insert 42 can be screwed radially from the interior to the second housing part 30 by screws 62. The screws 62 can pass through bores in the second housing part 30 and engage threaded sections of the insert part 44.

The first housing part 28 comprises fastening projections 64. The fastening projections 64 extend away from the first housing side wall 32 in axial direction. The fastening projections 64 are embodied here as one piece together with the first housing part 28.

The filter insert 42 which is pre-mounted at the second housing part 30 can be pushed onto the fastening projections 64. In doing so, the circumferential edge 58 engages the receiving groove 60. The housing part 30 and the filter insert 42 comprise bores through which screws 66 can be inserted radially from the exterior. The screws 66 engage threaded sections in the fastening projections 64. The filter insert 42 and the second housing part 30 can thus be pressed in radial direction against the first housing part 28, in particular its fastening projections 64.

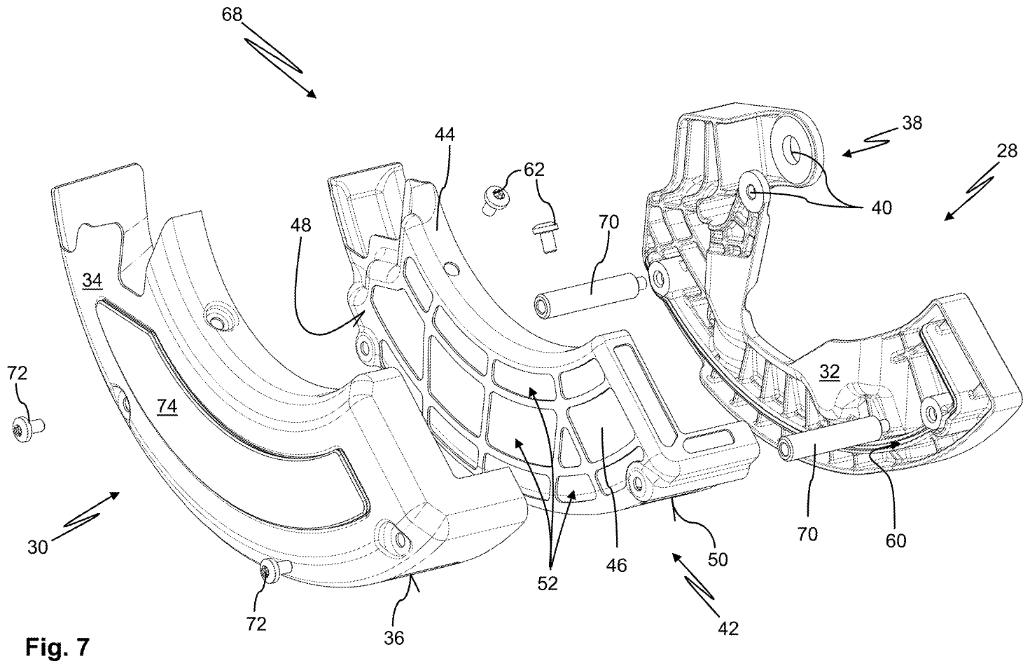

FIGS. 7, 8, and 9 show a further brake dust particle filter 68. The brake dust particle filter 68 corresponds in construction and function substantially to the afore described brake dust particle filter 18 illustrated in FIGS. 1 through 6. In the following, primarily the differences will be described. In other respects, reference is being had to the preceding description.

In the brake dust particle filter 68, an insert part 44 of a filter insert 42 is provided with a plurality of openings 52 in its side wall 48 which are covered by a filter medium 46, compare in particular FIG. 7. Openings 54 in a circumferential wall of the filter insert 42 are also covered by the filter medium 46.

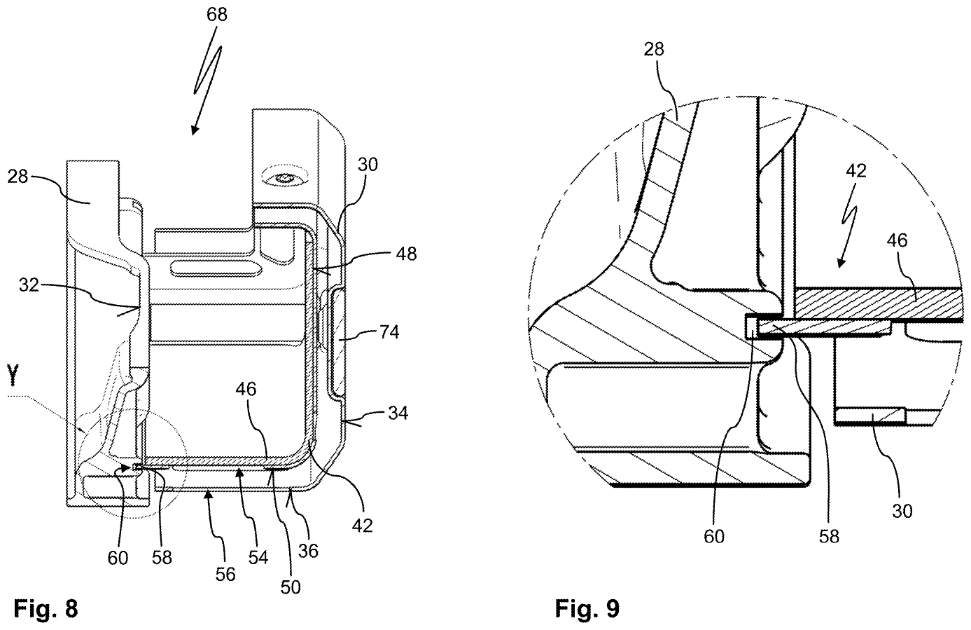

The filter medium 46 is embodied here as one piece, see FIG. 8. The two legs of its L-shape pass into each other in the region of the transition from the side wall 48 into the circumferential wall 50 of the insert part 44.

The side wall 48 projects here also in axial direction past the filter medium 46, compare FIGS. 8 and 9. The projection forms a curved circumferential edge 58 at the free end of the side wall 48. The circumferential edge 58 engages a receiving groove 60 at the first housing side wall 32, which groove is open toward a second housing side wall 34. In this way, a labyrinth seal between a first housing part 28 and the filter insert 42 is provided.

In the brake dust particle filter 68, fastening projections 70 in the form of stud bolts can be screwed onto the first housing part 28, compare FIG. 7. The filter insert 42 comprises receiving regions for the fastening projections 70. The filter insert 42, which is pre-mounted, for example, by means of screws 62 at a second housing part 30, can be pushed in axial direction onto the stud bolts which are fastened at the first housing part 28. The circumferential edge 58 then engages the receiving groove 60. For detachable fastening of the two housing parts 28, 30 and of the filter insert 42 at each other, screws 72 can be screwed in axial direction into the fastening projections 70. The screws 72 can pass through bores in the second housing part 30 and in the side wall 48 of the filter insert 42 and engage threaded sections in the fastening projections 70. In this way, the two housing parts 28, 30 and the filter insert 42 can be pressed against each other in axial direction.

At the housing 22, in particular at the second housing side wall 34 which is facing toward an exterior side of the vehicle, a decorative plate 74 can be attached, compare in particular FIG. 7. The decorative plate 74 and the housing 22 can have different colors.

### LIST OF REFERENCE CHARACTERS

disc brake assembly 10
brake disc 12
brake caliper 14
brake caliper holder 16
brake dust particle filter 18, 68
direction of rotation 20
housing 22
friction surfaces 24
circumferential surface 26
first housing part 28
second housing part 30
first housing side wall 32
second housing side wall 34
housing circumferential wall 36
fastening device 38
cutouts 40
filter insert 42
insert part 44
filter medium 46
side wall 48
circumferential wall 50
opening 52, 54
flow openings 56
circumferential edge 58
receiving groove 60
rope seal 61
screws 62, 66, 72
fastening projections 64, 70
decorative plate 74

What is claimed is:

1. A brake dust particle filter for a disc brake assembly, the brake dust particle filter comprising:
a housing comprising a first housing side wall, a second housing side wall, and a housing circumferential wall, wherein the housing circumferential wall extends between the first housing side wall and the second housing side wall;
a filter insert comprising a filter medium, wherein the filter insert is arranged in the housing and extends along one of the first and second housing side walls and along the housing circumferential wall;
wherein the filter insert comprises a curved circumferential edge;
wherein the housing comprises a curved receiving groove;
wherein the curved circumferential edge engages the curved receiving groove.

2. The brake dust particle filter according to claim 1, further comprising a rope seal arranged in the curved receiving groove, wherein the rope seal is configured to be compressed by the curved circumferential edge.

3. The brake dust particle filter according to claim 2, wherein the rope seal contains ceramic fibers and/or glass fibers.

4. The brake dust particle filter according to claim 1, wherein the curved receiving groove and the curved circumferential edge engaging the curved receiving groove form a labyrinth seal.

5. The brake dust particle filter according to claim 1, wherein the housing is of a two-part configuration comprised of a first housing part and a second housing part, wherein the first housing side wall is formed at the first housing part, and wherein the second housing side wall is formed at the second housing part.

6. The brake dust particle filter according to claim 5, wherein the first housing part comprises a fastening device configured to fasten the brake dust particle filter at a vehicle structure.

7. The brake dust particle filter according to claim 5, wherein the first housing part forms at least partially a splash guard of the disc brake assembly.

8. The brake dust particle filter according to claim 5, wherein the curved receiving groove is formed in the first housing part.

9. The brake dust particle filter according to claim 5, wherein the first housing part and the second housing part are detachably connected to each other.

10. The brake dust particle filter according to claim 9, wherein the first housing part comprises axial fastening projections, wherein the filter insert and the second housing part are configured to be fastened to the axial fastening projections.

11. The brake dust particle filter according to claim 10, wherein the axial fastening projections are embodied as one piece together with the first housing part.

12. The brake dust particle filter according to claim 10, wherein the axial fastening projections are configured to be screwed onto the first housing part.

13. The brake dust particle filter according to claim 10, wherein the filter insert and the second housing part are configured to be clamped in an axial direction against the first housing part.

14. The brake dust particle filter according to claim 10, wherein the filter insert and the second housing part are configured to be clamped in a radial direction against the first housing part.

15. The brake dust particle filter according to claim 14, wherein the filter insert and the second housing part are configured to be clamped in a radial direction against the axial fastening projections.

16. The brake dust particle filter according to claim 10, wherein the filter insert and the second housing part are configured to be screwed to each other radially and/or axially from an exterior of the housing.

17. The brake dust particle filter according to claim 16, further comprising screws passing through the second housing part and through the filter insert and engaging counter threads of the axial fastening projections.

18. The brake dust particle filter according to claim 16, wherein the filter insert comprises a circumferential wall and a side wall, wherein the circumferential wall and/or the side wall comprises at least one bore arranged to correspond with a positioning of the counter threads of the axial fastening projections.

19. The brake dust particle filter according to claim 1, wherein the curved circumferential edge dips in an axial direction into the curved receiving groove.

20. The brake dust particle filter according to claim 1, wherein the filter insert comprises an insert part comprising a side wall and a circumferential wall, wherein the side wall and/or the circumferential wall comprises at least one opening covered by the filter medium.

21. The brake dust particle filter according to claim 20, wherein the filter medium is welded to the insert part.

22. The brake dust particle filter according to claim 21, wherein the filter medium is welded to a rim of the at least one opening covered by the filter medium.

23. The brake dust particle filter according to claim 1, wherein the filter medium comprises a pleated bellows.

24. The brake dust particle filter according to claim 1, wherein the housing circumferential wall comprises one flow opening or a plurality of flow openings spaced apart from each other in a circumferential direction of the housing.

25. A disc brake assembly comprising a brake disc, a brake caliper, and a brake dust particle filter according to claim 1.

26. A filter insert for a brake dust particle filter of a disc brake assembly, wherein the filter insert is L-shaped and comprises a filter medium, wherein the filter insert is configured to at least partially cover a friction surface and a circumferential surface of a brake disc of the disc brake assembly, and wherein the filter insert comprises a curved circumferential edge projecting past the filter medium.

27. The filter insert according to claim 26, wherein the curved circumferential edge projects axially past the filter medium.

28. The filter insert according to claim 26, further comprising an insert part, wherein the filter medium is held non-detachably at the insert part.

29. The filter insert according to claim 28, wherein the curved circumferential edge is formed at the insert part.

30. A method of filtering brake dust with a brake dust particle filter of a disc brake assembly, the method comprising:
using a filter insert according to claim 26 in the brake dust particle filter.
